(19) United States
(12) Patent Application Publication
(10) Pub. No.: US 2015/0075398 A1
(43) Pub. Date: Mar. 19, 2015

(54) INKING DEVICE OF NUMBERING AND IMPRINTING MACHINE

(71) Applicant: KOMORI CORPORATION, TOKYO (JP)

(72) Inventor: Hiroyoshi KAMODA, Tsukuba-shi (JP)

(73) Assignee: KOMORI CORPORATION, Tokyo (JP)

(21) Appl. No.: 14/484,312

(22) Filed: Sep. 12, 2014

(30) Foreign Application Priority Data
Sep. 13, 2013 (JP) 2013-190088

(51) Int. Cl. B41L 27/04; B41L 19/00

(52) U.S. Cl. CPC B41L 27/04; B41L 19/00
USPC 101/350.1

(57) ABSTRACT

An inking device of a numbering and imprinting machine includes: a numbering unit provided on an outer peripheral portion of a numbering cylinder and configured to print a code onto a transported sheet; a partition member configured to partition the inside of the ink fountain such that inks are stored divided by their colors inside the ink fountain; an ink fountain roller configured to draw out the inks stored in the divided manner inside the ink fountain, such that the inks appear side by side in the roller axial direction; select rollers onto which the inks fed from the ink fountain roller are transferred, respectively; oscillating rollers onto which the inks fed from the select rollers are transferred, respectively; and form rollers configured to rotate such that convex portions thereof, onto which the inks fed from the oscillating rollers are transferred, come into contact with the numbering unit.

### TECHNICAL FIELD

The present invention relates to an inking device of a numbering and imprinting machine configured to feed inks of multiple colors to numbering units provided on a numbering cylinder.

### BACKGROUND ART

Numbering and imprinting for printing serial codes on securities, banknotes, and the like has been done by additionally printing such codes on printed products which have already been subjected to printing such as offset printing or intaglio printing. Moreover, numbering cylinders of numbering and imprinting machines capable of such numbering and imprinting include numbering units having carved letters of predetermined digits. These numbering units are configured to be fed with an ink stored in an ink fountain through a number of rollers.

Patent Literature 1, for example, discloses an inking device of a numbering and imprinting machine as described above which is capable of feeding an ink to numbering units of a numbering cylinder.

### CITATION LIST

### Patent Literature

{Patent Literature 1}Japanese Examined Patent Application Publication No. Hei 3-49753

### SUMMARY OF INVENTION

### Technical Problem

However, in the above conventional inking device, there is only one ink feed path, and printed codes are therefore expressed with only one color. In a case particularly where printed products are securities, banknotes, or the like as mentioned above, those printed products need many anti-counterfeit measures. In this case, expressing the codes of the printed products with multiple colors may provide a higher anti-counterfeit effect.

Thus, the present invention has been made to solve the above problem, and an object thereof is to provide an inking device of a numbering and imprinting machine capable of expressing a printed code with multiple colors to thereby provide a high anti-counterfeit effect to a printed product.

### Solution to Problem

In inking device of a numbering and imprinting machine according to a first aspect of the invention for solving the above problem provides an inking device of a numbering and imprinting machine, the inking device being configured to feed inks stored inside an ink fountain onto a numbering cylinder configured to print a code onto a transported sheet, the inking device including: a numbering unit provided on an outer peripheral portion of the numbering cylinder and configured to print a code onto a transported sheet; a partition member configured to partition an inside of the ink fountain in such a manner that inks of a plurality of colors are stored divided by the colors inside the ink fountain; an ink fountain roller configured to draw out the inks of the plurality of colors stored in the divided manner inside the ink fountain, in such a manner that the inks appear side by side in an axial direction of the ink fountain roller; a plurality of select rollers onto which at least one of the inks of the plurality of colors fed from the ink fountain roller is selectively transferred; a plurality of oscillating rollers which are provided respectively for the select rollers and supported in such a manner as to be movable in an axial direction of the oscillating rollers, and onto which the inks fed from the select rollers are transferred; and a plurality of form rollers provided respectively for the oscillating rollers, including convex portions on outer peripheral surfaces thereof, and configured to rotate in such a manner that the convex portions come into contact with the numbering unit, the convex portions being portions onto which the inks fed from the oscillating rollers are transferred.

An inking device of a numbering and imprinting machine according to a second aspect of the invention for solving the above problem is such that an annular convex portion onto which the inks fed from the ink fountain roller are transferred is formed on an outer peripheral surface of each of the select rollers in a convex shape over an entire area in a circumferential direction thereof, and one or more of the annular convex portions are disposed side by side in an axial direction of the select roller.

An inking device of a numbering and imprinting machine according to a third aspect of the invention for solving the above problem is such that a circumferential length of the numbering cylinder is a multiple integer of circumferential lengths of the form rollers, and the plurality of form rollers and the numbering cylinder rotate in synchronization with each other.

### Advantageous Effect of Invention

Thus, with the inking device of a numbering and imprinting machine according to the present invention, a code can be printed on a sheet with multiple colors used for different portions. Accordingly, the printed code can be expressed with multiple colors, and therefore a high-counterfeit effect can be provided to the printed product.

### BRIEF DESCRIPTION OF DRAWINGS

FIG. 1 is a side view of an inking device of a numbering and imprinting machine according to one embodiment of the present invention.

FIG. 2 is a plan view of an ink fountain.

FIG. 3 is a view showing the positional relationship between form rollers and a numbering cylinder.

FIGS. 4A to 4E are views sequentially showing how one ink is fed.

FIGS. 5A to 5E are views sequentially showing how another ink is fed.

FIG. 6 is a view showing a sheet on which codes are printed.

FIG. 7 is an example of use of different colors in printing a code with a combination of numbers and a letter.

FIG. 8 is an example of use of different colors in printing a code with a combination of numbers and a sign.

### DESCRIPTION OF EMBODIMENT

Hereinafter, an inking device of a numbering and imprinting machine according to the present invention will be described in detail with reference to the drawings.

### Embodiment

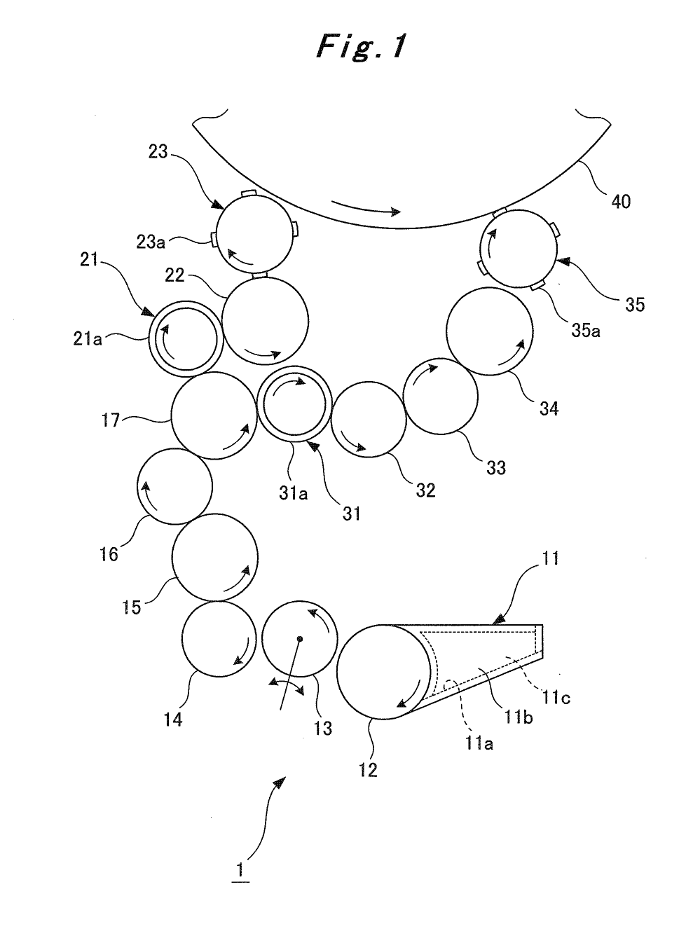

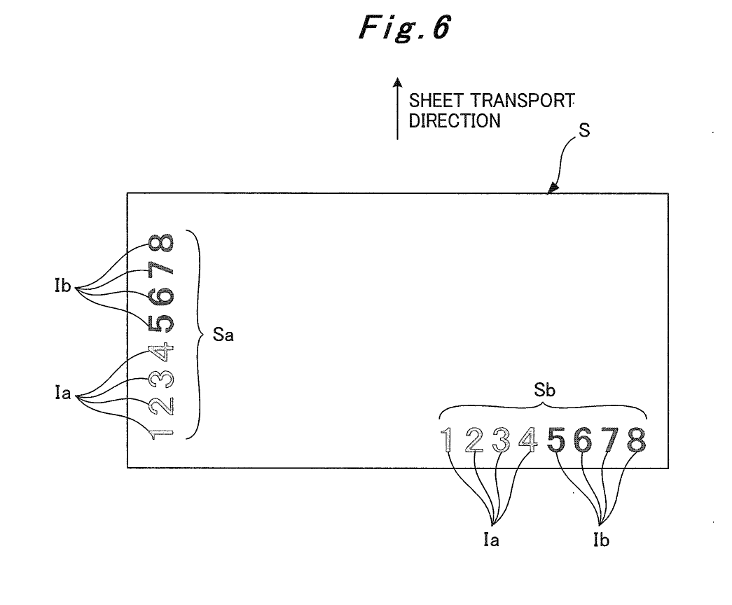

As shown in FIG. 1, a numbering and imprinting machine includes an inking device 1. Here, the numbering and imprinting machine is configured to print serial codes on transported sheets S. Moreover, as shown in FIG. 6, a sheet S subjected to the numbering and imprinting by the numbering and imprinting machine has, for example, a lengthwise code Sa and a widthwise code Sb printed thereon.

The lengthwise code Sa is a multiple-digit code arranged in one line in the sheet lengthwise direction on one end side in the sheet widthwise direction (left side in the sheet widthwise direction). The widthwise code Sb is a multiple-digit code arranged in one line in the sheet widthwise direction on the other end side in the sheet widthwise direction (right side in the sheet widthwise direction). Note that the lengthwise code Sa and the widthwise code Sb will each be described as an eight-digit code in this embodiment.

Here, the lengthwise code Sa and the widthwise code Sb are each expressed by using inks Ia, Ib of multiple colors. Specifically, the first four digits of the lengthwise code Sa and the widthwise code Sb are printed by using only the ink Ia of a first color (one color), while the last four digits of the lengthwise code Sa and the widthwise code Sb are printed by using only the ink Ib of a second color (another color).

To do so, the inking device 1 is capable of supplying the inks Ia, Ib of multiple colors and is provided below a transported sheet S.

Next, the structure of the inking device 1 will be described in detail with reference to drawings.

First of all, the above-mentioned numbering and imprinting machine is configured to transport a sheet S in the lengthwise direction thereof. Thus, the sheet lengthwise direction corresponds to the sheet transport direction, and the sheet widthwise direction corresponds to a direction perpendicular to the sheet transport direction. Further, in the inking device 1 to be described below, the axial directions of rollers that form the inking device 1 correspond to the sheet widthwise direction, and the circumferential directions of these rollers corresponds to the sheet lengthwise direction.

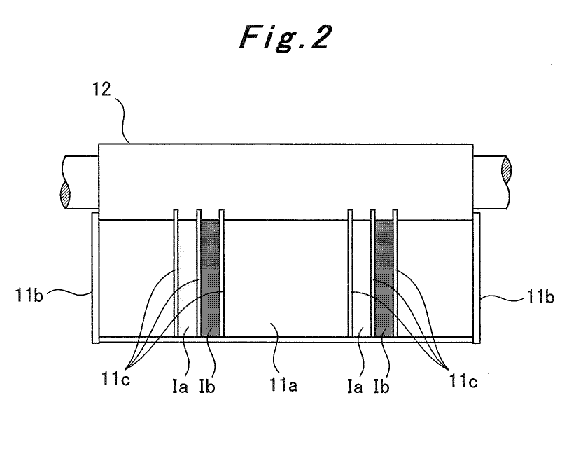

As shown in FIGS. 1 and 2, an ink fountain 11 is provided at a lower portion of the inking device 1, and an ink fountain roller 12 is in rotatable contact with this ink fountain 11. The ink fountain 11 includes a bottom plate 11a, a pair of left and right side plates 11b, and multiple partition members 11c.

The bottom plate 11a is inclined downward toward the ink fountain roller 12. Moreover, the side plates 11b are fixed to left and right side portions of the bottom plate 11a. Furthermore, the partition members 11c are disposed between the pair of left and right side plates 11b and supported in such a manner as to be movable in the widthwise direction of the bottom plate 11a (axial direction of the ink fountain roller 12).

Specifically, the inks Ia, Ib of different colors can be stored respectively in spaces surrounded by the bottom plate 11a, the side plates 11b, the partition members 11c, and the outer peripheral surface of the ink fountain roller 12. Among these parts, the positions of the partition members 11c are adjusted in the axial direction of the ink fountain roller 12 based on the positions of the lengthwise code Sa and the widthwise code Sb on the sheet S in the sheet widthwise direction. For example, as shown in FIG. 2, the inks Ia, Ib are stored between pairs of adjacent partitioning plates 11c.

Moreover, as shown in FIG. 1, an ink ductor roller 13 and a distribution roller 14 are rotatably supported in front of the ink fountain roller 12. Among these rollers, the ink ductor roller 13 is supported in such a manner as to be swingable between the ink fountain roller 12 and the distribution roller 14 and can therefore be in contact alternately with the ink fountain roller 12 and the distribution roller 14.

Further, a drive roller 15 is in rotatable contact with the distribution roller 14 at a position downstream of the contact position with the ink ductor roller 13 in the rotational direction of the distribution roller 14 (downstream in the direction of the ink feed). In addition, a distribution roller 16 is in rotatable contact with the drive roller 15 at a position downstream of the contact position with the distribution roller 14 in the rotational direction of the drive roller 15. Also, a drive roller 17 is in rotatable contact with the distribution roller 16 at a position downstream of the contact position with the drive roller 15 in the rotational direction of the distribution roller 16.

Furthermore, a select roller 31 is in rotatable contact with the drive roller 17 at a position downstream of the contact position with the distribution roller 16 in the rotational direction of the drive roller 17. Also, a select roller 21 is in rotatable contact with the drive roller 17 at a position downstream of the contact position with the select roller 31 in the rotational direction of the drive roller 17.

Note that the select rollers 21, 31 are distribution rollers onto which the inks Ia, Ib fed from the drive roller 17 are transferred individually. As will be described later in detail, of the inks Ia, Ib fed to the drive roller 17, at least the ink Ia of a given color is selectively transferred onto the select roller 21 from the drive roller 17. On the other hand, of the inks Ia, Ib fed to the drive roller 17, at least the ink Ib of a given color is selectively transferred onto the select roller 31 from the drive roller 17.

An oscillating roller 22 is in rotatable contact with the select roller 21 at a position downstream of the contact position with the drive roller 17 in the rotational direction of the select roller 21. Moreover, a form roller 23 is in rotatable contact with the oscillating roller 22 at a position downstream of the contact position with the select roller 21 in the rotational direction of the oscillating roller 22. Furthermore, a numbering cylinder 40 of the numbering and imprinting machine is in rotatable contact with the form roller 23 at a position downstream of the contact position with the oscillating roller 22 in the rotational direction of the form roller 23.

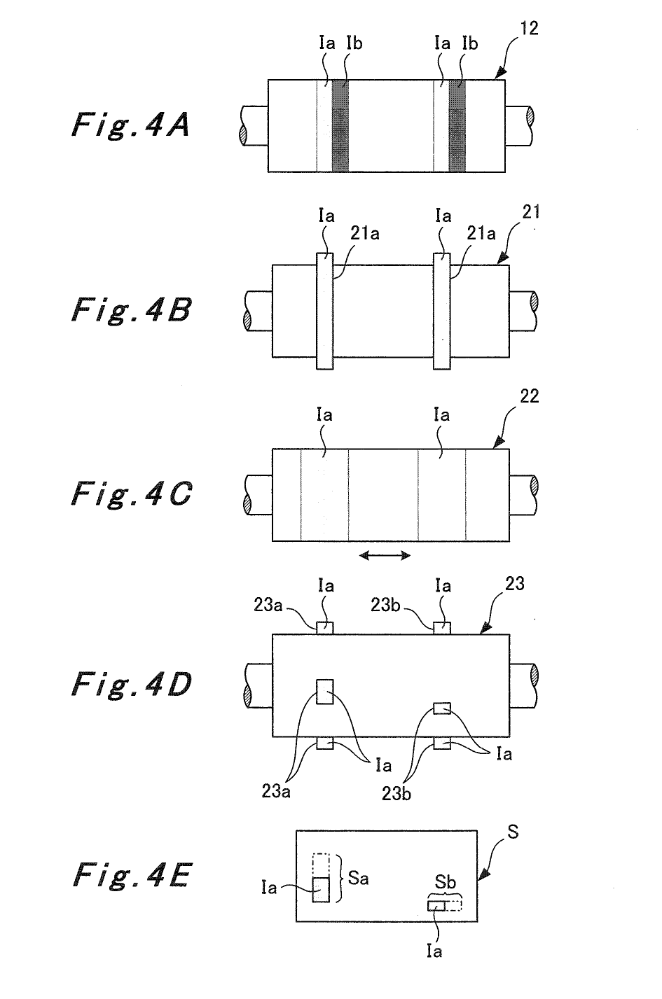

Here, as shown in FIG. 4B, multiple annular convex portions 21a are formed on the outer peripheral surface of the select roller 21 in a convex shape over the entire area in the circumferential direction. Thus, the ink Ia is transferred only onto the outer peripheral surfaces (top surfaces) of the annular convex portions 21a of the select roller 21.

Specifically, the positions of the annular convex portions 21a in the select-roller axial direction are positions corresponding to the ink Ia selected from among the inks Ia, Ib fed side by side in the select-roller axial direction, and also corresponding respectively to the position of the lengthwise code Sa on the sheet S in the sheet widthwise direction and the position of the first-four-digit portion of the widthwise code Sb on the sheet S in the sheet widthwise direction.

Moreover, the oscillating roller 22 is supported in such a manner as to be movable in the axial direction thereof, and therefore oscillates by a predetermined oscillation width. Further, as shown in FIG. 4D, multiple convex portions 23a, 23b are formed on the outer peripheral surface of the form roller 23 in convex shapes along the circumferential direction thereof. Thus, the ink Ia is transferred only onto the outer peripheral surfaces (top surfaces) of the convex portions 23a, 23b of the form roller 23.

Specifically, the position of each convex portion 23a in the form-roller axial direction corresponds to the position of the lengthwise code Sa on the sheet S in the sheet widthwise direction, and the position of the convex portion 23a in the form-roller circumferential direction corresponds to the position of the first-four-digit portion of the lengthwise code Sa on the sheet S in the sheet lengthwise direction. On the other hand, the position of each convex portion 23b in the form-roller axial direction corresponds to the position of the first-four-digit portion of the widthwise code Sb on the sheet S in the sheet widthwise direction, and the position of the convex portion 23b in the form-roller circumferential direction corresponds to the position of the widthwise code Sb on the sheet S in the sheet lengthwise direction.

On the other hand, a distribution roller 32 is in rotatable contact with the select roller 31 at a position downstream of the contact position with the drive roller 17 in the rotational direction of the select roller 31, and a distribution roller 33 is in rotatable contact with this distribution roller 32 at a position downstream of the contact position with the select roller 31 in the rotational direction of the distribution roller 32. Further, an oscillating roller 34 is in rotatable contact with the distribution roller 33 at a position downstream of the contact position with the distribution roller 32 in the rotational direction of the distribution roller 33, and a form roller 35 is in rotatable contact with this oscillating roller 34 at a position downstream of the contact position with the distribution roller 33 in the rotational direction of the oscillating roller 34. Furthermore, the numbering cylinder 40 is in rotatable contact with the form roller 35 at a position downstream of the contact position with the oscillating roller 34 in the rotational direction of the form roller 35.

Note that an impression cylinder (not shown) of the numbering and imprinting machine is in rotatable contact with the numbering cylinder 40 at a position downstream of the contact position with the form roller 35 in the rotational direction of the numbering cylinder 40. This impression cylinder is configured to hold and transport the sheet S.

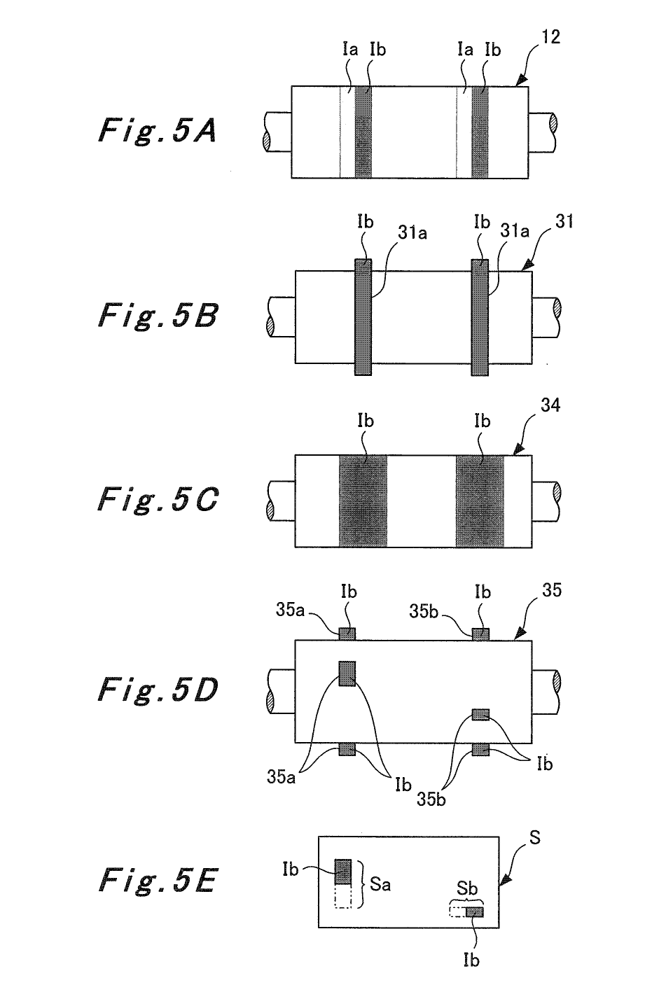

Here, as shown in FIG. 5B, multiple annular convex portions 31a are formed on the outer peripheral surface of the select roller 31 in a convex shape over the entire area in the circumferential direction thereof. Thus, the ink Ib is transferred only onto the outer peripheral surfaces (top surfaces) of the annular convex portions 31a of the select roller 31.

Specifically, the positions of the annular convex portions 31a in the select-roller axial direction are positions corresponding to the ink Ib selected from among the inks Ia, Ib fed side by side in the select-roller axial direction, and also corresponding respectively to the position of the lengthwise code Sa on the sheet S in the sheet widthwise direction and the position of the last-four-digit portion of the widthwise code Sb on the sheet S in the sheet widthwise direction.

Moreover, the oscillating roller 34 is supported in such a manner as to be movable in the axial direction thereof and therefore oscillates by a predetermined oscillation width. Further, as shown in FIG. 5D, multiple convex portions 35a, 35b are formed on the outer peripheral surface of the form roller 35 in convex shapes along the circumferential direction. Thus, the ink Ib is transferred only onto the outer peripheral surfaces of the convex portions 35a, 35b of the form roller 35.

Specifically, the position of each convex portion 35a in the form-roller axial direction corresponds to the position of the lengthwise code Sa on the sheet S in the sheet widthwise direction, and the position of the convex portion 35a in the form-roller circumferential direction corresponds to the position of the last-four-digit portion of the lengthwise code Sa on the sheet S in the sheet lengthwise direction. On the other hand, the position of each convex portion 35b in the form-roller axial direction corresponds to the position of the last-four-digit portion of the widthwise code Sb on the sheet S in the sheet widthwise direction, and the position of the convex portion 35b in the form-roller circumferential direction corresponds to the position of the widthwise code Sb on the sheet S in the sheet lengthwise direction.

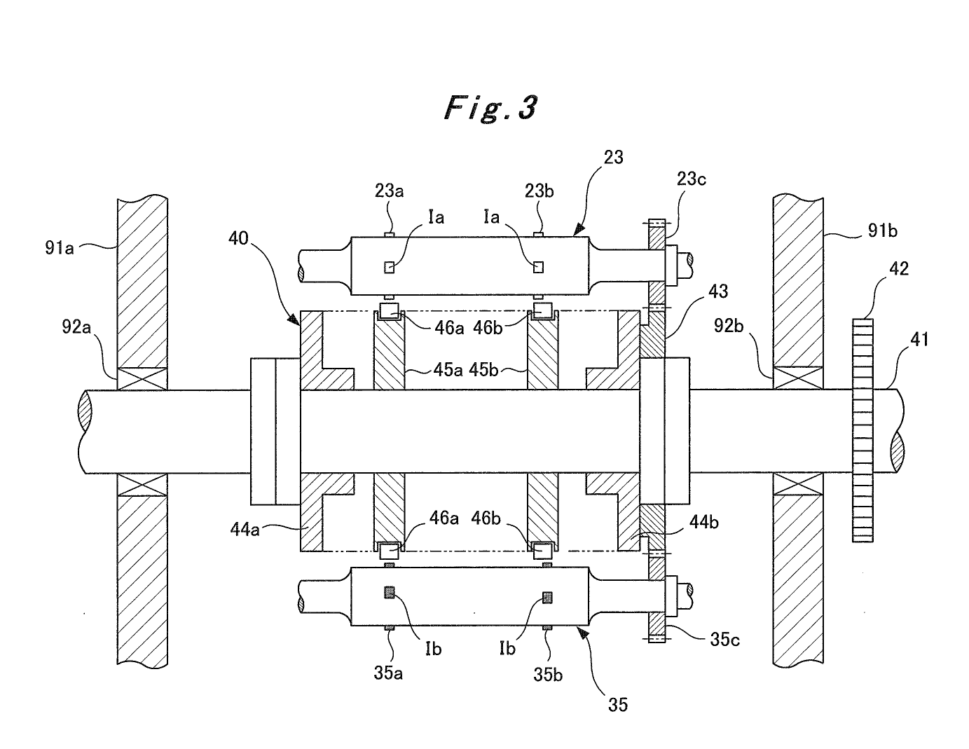

Next, as shown in FIG. 3, the numbering cylinder 40 includes a numbering cylinder shaft 41 at the center thereof. Left and right end portions of this numbering cylinder shaft 41 are rotatably supported on a pair of left and right frames 91a, 91b of the numbering and imprinting machine with bearings 92a, 92b interposed therebetween, respectively. Further, a drive gear 42 is fitted on the numbering cylinder shaft 41 at the outer side of the frame 91b, and a coupling gear 43 is fitted on the numbering cylinder shaft 41 at the inner side of the frame 91b.

The drive gear 42 is a gear to which drive of a main-unit drive motor (not shown) configured to drive the entire numbering and imprinting machine is transmitted. On the other hand, the coupling gear 43 is in mesh with coupling gears 23c, 35c disposed coaxially with the rotary shafts of the form rollers 23, 35, respectively. Thus, as the numbering and imprinting machine is driven, the numbering cylinder 40 and the form rollers 23, 35 are rotated in synchronization with each other. Note that the circumferential length of the numbering cylinder 40 is a multiple integer of the circumferential lengths of the form rollers 23, 35.

Moreover, a pair of left and right circular support plates 44a, 44b and a pair of left and right ring members 45a, 45b are fitted on the numbering cylinder shaft 41 in such a manner as to face the form rollers 23, 35. Moreover, the positions of the ring members 45a, 45b can be adjusted in the numbering-cylinder axial direction. The circular support plates 44a, 44b are provided at the left and right sides of the ring members 45a, 45b, respectively, and the outer peripheral surfaces of the circuit support plates 44a, 44b serve as a reference position for adjusting the gap between (the distance between the axes of) the numbering cylinder 40 and the impression cylinder.

Further, multiple numbering units 46a, 46b are provided on outer peripheral portions of the ring members 45a, 45b, respectively, at an equal interval in the circumferential direction thereof. Each numbering unit 46a is configured to print a given lengthwise code Sa onto a sheet S, and an eight-digit number arranged in one line in the numbering-cylinder circumferential direction is carved in the form of a relief printing plate on an outer peripheral portion of the numbering unit 46a. Moreover, the convexly carved eight-digit number of the numbering unit 46a increments for each printing of a sheet, and also a digit(s) increments at every ten increments. On the other hand, each numbering unit 46b is configured to print a given widthwise code Sb onto a sheet S, and an eight-digit number arranged in one line in the numbering-cylinder axial direction are carved in the form of a relief printing plate on an outer peripheral portion of the numbering unit 46b. Moreover, the convexly carved eight-digit number of the numbering unit 46b increments for each printing of a sheet, and also a digit(s) increments at every ten increments.

Specifically, the numbering units 46a on the ring member 45a are located at the same positions as the convex portions 23a, 35a of the form rollers 23, 35, and the lengthwise code Sa on the sheet S in the numbering-cylinder axial direction (form-roller axial direction, sheet widthwise direction).

Further, the convex portions 23a, 35a and the numbering units 46a can always come into contact with each other by the synchronous rotation of the form rollers 23, 35 and the numbering cylinder 40. Specifically, each convex portion 23a comes into contact with the first-four-digit portion of the convexly carved eight-digit number of a given one of the numbering units 46a to transfer the ink Ia onto that portion. On the other hand, each convex portion 35a comes into contact with the last-four-digit portion of the convexly carved eight-digit number of a given one of the numbering units 46a to transfer the ink Ib onto that portion.

Similarly, the numbering units 46b on the ring member 45b are located at the same positions as the convex portions 23b, 35b of the form rollers 23, 35, and the widthwise code Sb on the sheet S in the numbering-cylinder axial direction (form-roller axial direction, sheet widthwise direction).

Further, the convex portions 23b, 35b and the numbering units 46b can always come into contact with each other by the synchronous rotation of the form rollers 23, 35 and the numbering cylinder 40. Specifically, each convex portion 23b comes into contact with the first-four-digit portion of the convexly carved eight-digit number of a given one of the numbering units 46b to transfer the ink Ia onto that portion. On the other hand, each convex portion 35b comes into contact with the last-four-digit portion of the convexly carved eight-digit number of a given one of the numbering units 46b to transfer the ink Ib onto that portion.

Next, the ink feed operation of the inking device 1 will be described in detail with reference drawings.

First, as shown in FIGS. 2, 4A, and 5A, the inks Ia, Ib have been stored in the spaces partitioned by the multiple partition members 11c inside the ink fountain 11. Thus, as the ink fountain roller 12 is rotated, these stored inks Ia, Ib are transferred next to each other (side by side) in the ink-fountain-roller axial direction onto the outer peripheral surface of the ink fountain roller 12.

Thereafter, as shown in FIG. 1, the inks Ia, Ib fed to the ink fountain roller 12 are transferred onto the outer peripheral surface of the distribution roller 14 by swing of the ink ductor roller 13, and then transferred onto the outer peripheral surface of the drive roller 17 via the outer peripheral surfaces of the drive roller 15 and distribution roller 16.

Here, as shown in FIG. 4B, of the inks Ia, Ib transferred onto the drive roller 17, the ink Ia is transferred onto the outer peripheral surfaces of the annular convex portions 21a of the select roller 21.

Then, as shown in FIG. 4C, the ink Ia transferred onto the annular convex portions 21a of the select roller 21 is transferred onto the outer peripheral surface of the oscillating roller 22. In this step, the oscillating roller 22 is oscillating by the predetermined oscillation width in the oscillating-roller axial direction.

When the ink Ia is transferred from the annular convex portions 21a of the select roller 21 onto the oscillating roller 22 as described above, the oscillating movement of the oscillating roller 22 widens the width of ink transfer on the outer peripheral surface of the oscillating roller 22 in the oscillating-roller axial direction to a greater width than the width of ink transfer on the outer peripheral surfaces of the annular convex portions 21a in the select-roller axial direction.

Then, as shown in FIG. 4D, the ink Ia transferred onto the oscillating roller 22 is transferred onto the outer peripheral surfaces of the convex portions 23a, 23b of the form roller 23.

Thereafter, as shown in FIG. 3, the ink Ia transferred onto the convex portions 23a, 23b of the form roller 23 is transferred onto the numbering units 46a, 46b of the numbering cylinder 40, respectively. Specifically, the ink Ia transferred onto one of the convex portions 23a is transferred onto the first-four-digit portion of the convexly carved number of one of the numbering units 46a, while the ink Ia transferred onto one of the convex portions 23b is transferred onto the first-four-digit portion of the convexly carved number of one of the numbering units 46b.

Then, as shown in FIG. 4E, the ink Ia transferred onto the numbering unit 46a is transferred onto a sheet S transported to a position at which the numbering cylinder 40 and the impression cylinder face each other, to thereby print the first four digits of the lengthwise code Sa. Also, the ink Ia transferred onto the numbering unit 46b is transferred onto the sheet S transported to the position at which the numbering cylinder 40 and the impression cylinder face each other, to thereby print the first four digits of the widthwise code Sb.

On the other hand, as shown in FIG. 5B, of the inks Ia, Ib transferred onto the drive roller 17, the ink Ib is transferred onto the outer peripheral surfaces of the annular convex portions 31a of the select roller 31.

Then, as shown in FIG. 5C, the ink Ib transferred onto the annular convex portions 31a of the select roller 31 is transferred onto the outer peripheral surface of the oscillating roller 34 via the outer peripheral surfaces of the distribution rollers 32, 33. In this step, the oscillating roller 34 is oscillating by the predetermined oscillation width in the oscillating-roller axial direction.

When the ink Ib is transferred from the annular convex portions 31a of the select roller 31 onto the oscillating roller 34 as described above, the oscillating movement of the oscillating roller 34 widens the width of ink transfer on the outer peripheral surface of the oscillating roller 34 in the oscillating-roller axial direction to a greater width than the width of ink transfer on the outer peripheral surfaces of the annular convex portions 31a in the select-roller axial direction.

Then, as shown in FIG. 5D, the ink Ib transferred onto the oscillating roller 34 is transferred onto the outer peripheral surfaces of the convex portions 35a, 35b of the form roller 35.

Thereafter, as shown in FIG. 3, the ink Ib transferred onto the convex portions 35a, 35b of the form roller 35 is transferred onto the numbering units 46a, 46b of the numbering cylinder 40, respectively. Specifically, the ink Ib transferred onto one of the convex portions 35a is transferred onto the last-four-digit portion of the convexly carved number of one of the numbering units 46a, while the ink Ib transferred onto the convex portions 35b is transferred onto the last-four-digit portion of the convexly carved number of one of the numbering units 46b.

Then, as shown in FIG. 5E, the ink Ib transferred onto the numbering unit 46a is transferred onto the sheet S transported to the position at which the numbering cylinder 40 and the impression cylinder face each other, to thereby print the last four digits of the lengthwise code Sa. Also, the ink Ib transferred onto the numbering unit 46b is transferred onto the sheet S transported to the position at which the numbering cylinder 40 and the impression cylinder face each other, to thereby print the last four digits of the widthwise code Sb.

According to the above operation, the inks Ia, Ib of different colors are transferred onto different portions of the numbering unit 46a of the numbering cylinder 40, and the inks Ia, Ib of the different colors are transferred onto different portions of the numbering unit 46b of the numbering cylinder 40. As a result, as shown in FIG. 6, the lengthwise code Sa and the widthwise code Sb each having the two different colors in different portions are printed onto a transported sheet S.

Thus, with the inking device 1 of the numbering and imprinting machine according to the present invention, the lengthwise code Sa and the widthwise code Sb can each be printed onto a sheet S in a different color for each half digits. Accordingly, the printed codes can be expressed with multiple colors, and a high anti-counterfeit effect can therefore be provided to the printed product.

In the embodiment described above, the serial code printed by each of the numbering units 46a, 46b of the numbering cylinder 40 is a code with only numbers. Note, however, that the serial code may be a code with a combination of numbers and letters, a code with a combination of numbers and signs, or a code with only signs.

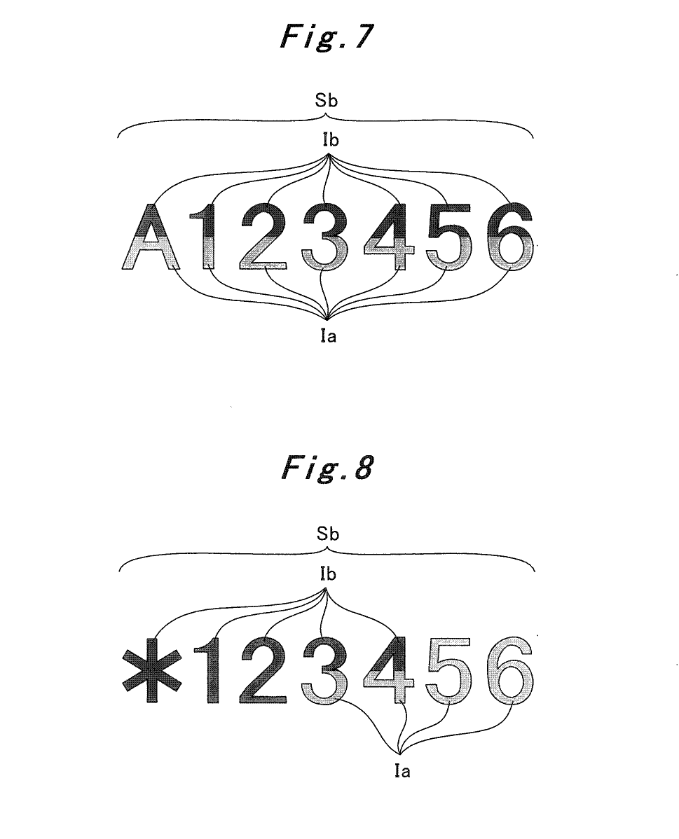

For example, when a seven-digit widthwise code Sb with a combination of numbers and a letter as shown in FIG. 7 is to be printed on a sheet S, the positions of the convex portions 23b, 35b of the form rollers 23, 35 in the form-roller axial direction and the form-roller circumferential direction may be adjusted such that an upstream portion of the widthwise code Sb in the sheet transport direction can be printed with the ink Ia, and a downstream portion of the widthwise code Sb in the sheet transport direction can be printed with the ink Ib.

Moreover, when a seven-digit widthwise code Sb with a combination of numbers and a sign as shown in FIG. 8 is to be printed on a sheet S, the positions of the convex portions 23b, 35b of the form rollers 23, 35 in the form-roller axial direction and the form-roller circumferential direction may be adjusted such that upstream portions of only certain digits (only selected digits) of the widthwise code Sb in the sheet transport direction can be printed with the ink Ia, and a downstream portion of only the certain digits of the widthwise code Sb in the sheet transport direction can be printed with the ink Ib.

Thus, the widthwise code Sb can be printed on a sheet S with different colors in the upstream portion(s) in the sheet transport direction and the downstream portion(s) in the sheet transport direction. Accordingly, even in a case of a code with a combination of numbers and letters or signs, the code can be expressed with multiple colors, and a high anti-counterfeit effect can therefore be provided to the printed product.

### cl INDUSTRIAL APPLICABILITY

The present invention is applicable to inking devices of numbering and imprinting machines capable of maintaining the thickness of ink constant.

### REFERENCE SIGNS LIST

1 INKING DEVICE

11 INK FOUNTAIN

11c PARTITION MEMBER

12 INK FOUNTAIN ROLLER

21 SELECT ROLLER

21a ANNULAR CONVEX PORTION

22 OSCILLATING ROLLER

23 FORM ROLLER

23a, 23b CONVEX PORTION

31 SELECT ROLLER

31a ANNULAR CONVEX PORTION

34 OSCILLATING ROLLER

35 FORM ROLLER

35a, 35b CONVEX PORTION

40 NUMBERING CYLINDER

46a, 46b NUMBERING UNIT

Ia, Ib INK

S SHEET

Sa LENGTHWISE CODE

Sb WIDTHWISE CODE

1. An inking device of a numbering and imprinting machine, the inking device being configured to feed inks stored inside an ink fountain onto a numbering cylinder configured to print a code onto a transported sheet, the inking device comprising:
a numbering unit provided on an outer peripheral portion of the numbering cylinder and configured to print a code onto a transported sheet;
a partition member configured to partition an inside of the ink fountain in such a manner that inks of a plurality of colors are stored divided by the colors inside the ink fountain;
an ink fountain roller configured to draw out the inks of the plurality of colors stored in the divided manner inside the ink fountain, in such a manner that the inks appear side by side in an axial direction of the ink fountain roller;
a plurality of select rollers onto which at least one of the inks of the plurality of colors fed from the ink fountain roller is selectively transferred;
a plurality of oscillating rollers which are provided respectively for the select rollers and supported in such a manner as to be movable in an axial direction of the oscillating rollers, and onto which the inks fed from the select rollers are transferred; and
a plurality of form rollers provided respectively for the oscillating rollers, including convex portions on outer peripheral surfaces thereof, and configured to rotate in such a manner that the convex portions come into contact with the numbering unit, the convex portions being portions onto which the inks fed from the oscillating rollers are transferred.

2. The inking device of a numbering and imprinting machine according to claim 1, wherein
an annular convex portion onto which the inks fed from the ink fountain roller are transferred is formed on an outer peripheral surface of each of the select rollers in a convex shape over an entire area in a circumferential direction thereof, and
one or more of the annular convex portions are disposed side by side in an axial direction of the select roller.

3. The inking device of a numbering and imprinting machine according to claim 1, wherein
a circumferential length of the numbering cylinder is a multiple integer of circumferential lengths of the form rollers, and
the plurality of form rollers and the numbering cylinder rotate in synchronization with each other.
